(19) United States
(12) Patent Application Publication
(10) Pub. No.: US 2025/0286291 A1
(43) Pub. Date: Sep. 11, 2025

(54) TERMINAL BLOCK, AND I/O UNIT

(71) Applicant: FANUC CORPORATION, Yamanashi (JP)

(72) Inventors: Masahiro SAEKI, Yamanashi-ken (JP); Shinichi KUWAHATA, Yamanashi-ken (JP); Jens OESTERHAUS, Detmold (DE); Jan MEIER, Detmold (DE); Ralf SCHUMACHER, Lemgo (DE); Klaus PUESCHNER, Detmold (DE); Torsten DIEKMANN, Leopoldshoehe (DE)

(21) Appl. No.: 18/858,519

(22) PCT Filed: Apr. 28, 2022
(86) PCT No.: PCT/JP2022/019304

§ 371 Date: Oct. 21, 2024

(51) Int. Cl. H01R 9/24

(52) U.S. Cl. CPC H01R 9/2458

(57) ABSTRACT

A terminal block includes a plurality of inserted portions and a plurality of release operators, wherein: the inserted portions include first inserted portions and second inserted portions which are arranged in a row in a first direction, and which have mutually different positions in relation to the first direction and a second direction perpendicular to the first direction; and the plurality of release operators are arranged in the first direction, in different positions to the first inserted portions and the second inserted portions in relation to the second direction.

### TECHNICAL FIELD

The present invention relates to a terminal block and an I/O unit including the terminal block.

### BACKGROUND ART

JP 2007-242486 A discloses a terminal block (terminal block device). The terminal block is attached to an electrical device. The terminal block includes a plurality of insertion-receiving portions (terminals) and a plurality of release operating elements (push buttons). The plurality of release operating elements correspond to different insertion-receiving portions.

### SUMMARY OF THE INVENTION

All the insertion-receiving portions according to JP 2007-242486 A are arranged in a row along the height direction. Here, it is preferable that the interval between the insertion-receiving portions adjacent to each other in the height direction has a certain length. However, in this case, the terminal block becomes large in the height direction.

In order to suppress the terminal block from becoming large in the height direction, it is conceivable to arrange the plurality of insertion-receiving portions in two rows. By arranging the plurality of insertion-receiving portions in two rows, the terminal block is prevented from being large in the height direction.

In this case, however, two rows of the plurality of insertion-receiving portions are formed. The two rows are arranged in the width direction orthogonal to the height direction. In other words, the plurality of insertion-receiving portions are arranged in the width direction. As a result, the terminal block becomes large in the width direction.

In view of the above, there is a problem that it is difficult to configure a small and thin terminal block.

The present invention has the object of solving the aforementioned problem.

A first aspect of the invention is a terminal block including: a plurality of insertion-receiving portions into which a plurality of external terminals are inserted, respectively, and which are provided respectively with a plurality of connection terminals each connected to a corresponding one of the inserted external terminals; and a plurality of release operating elements each configured to release connection between a corresponding one of the plurality of external terminals and a corresponding one of the plurality of connection terminals, wherein the plurality of insertion-receiving portions include: a plurality of first insertion-receiving portions arranged in a row along a first direction; and a plurality of second insertion-receiving portions arranged in a row along the first direction at positions that are different from positions of the plurality of first insertion-receiving portions in a second direction orthogonal to the first direction, and wherein the plurality of second insertion-receiving portions are disposed at positions that are different from the positions of the plurality of first insertion-receiving portions in the first direction, and the plurality of release operating elements corresponding to the plurality of first insertion-receiving portions and the plurality of release operating elements corresponding to the plurality of second insertion-receiving portions are arranged along the first direction at positions that are different from the positions of the plurality of first insertion-receiving portions and the positions of the plurality of second insertion-receiving portions in the second direction.

A second aspect of the invention is characterized by an I/O unit including the terminal block according to the first aspect, wherein the I/O unit has a flat plate shape, and a thickness direction of the flat plate shape is the second direction.

According to the present invention, it is possible to provide a small and thin terminal block.

### BRIEF DESCRIPTION OF DRAWINGS

FIG. 1A is a diagram showing a communication system (station) including an I/O unit according to an embodiment; FIG. 1B is a configuration diagram of the I/O unit of FIG. 1A;

FIG. 2 is a front view of a front unit;

FIG. 3A is an end view taken along line IIIA-IIIA of FIG. 2; FIG. 3B is an end view showing a state where an external terminal is inserted into a first insertion-receiving portion in FIG. 3A; FIG. 3C is an end view showing a state where an operator operates a release operating element in FIG. 3B;

FIG. 4 is an end view taken along line IV-IV of FIG. 2;

FIG. 5A is a front view of a front unit in Comparative Example 1 to which the present embodiment is not applied; FIG. 5B is a front view of a front unit in Comparative Example 2 to which the present embodiment is not applied; FIG. 5C is a front view of a front unit in Comparative Example 3 to which the present embodiment is not applied;

FIG. 6A is a perspective view of a front unit according to a first modification; FIG. 6B is a view showing a plurality of connector units stacked in a height direction;

FIG. 7A is a front view of a front unit according to a second modification; FIG. 7B is a front view of another example of the front unit according to the second modification; and

FIG. 8A is a perspective view of a front unit according to a third modification; FIG. 8B is a diagram schematically showing an internal configuration of a first unit; and FIG. 8C is a diagram schematically showing an internal configuration of a second unit.

### DETAILED DESCRIPTION OF THE INVENTION

### Embodiments

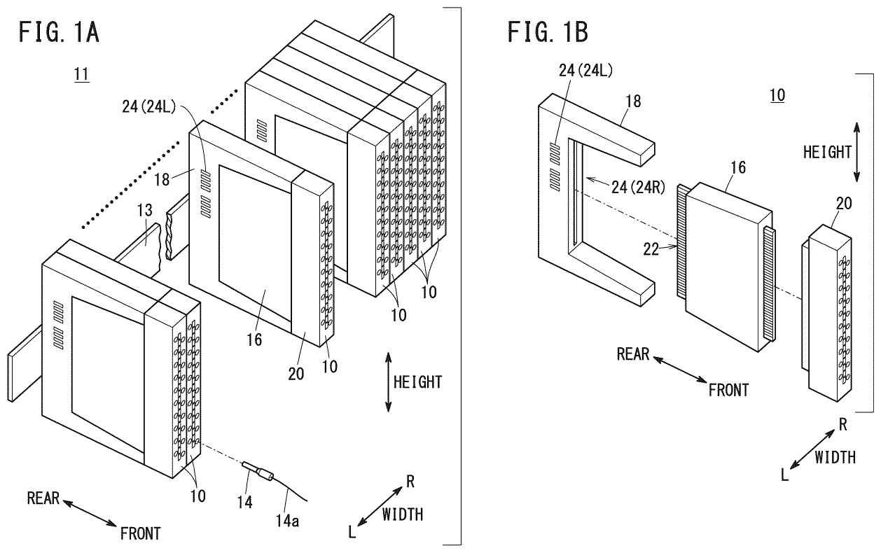

FIG. 1A is a diagram illustrating a communication system (station) 11 including an I/O unit (input/output unit) 10 according to an embodiment. FIG. 1B is a configuration diagram of the I/O unit 10 of FIG. 1A.

A plurality of arrows shown in each drawing indicate directions (height, width, and front-rear) used in the following description. The height direction, the width direction, and the front-rear direction (forward and rearward direction) are orthogonal to each other. The width direction and the front-rear direction are parallel to a horizontal plane. The width direction is a collective term for the L-direction and the R-direction. The L-direction and the R-direction are opposite to each other.

The communication system 11 is, for example, a system that inputs and outputs signals between a control device and a plurality of devices in order for the control device and the plurality of devices to communicate with each other. The communication system 11 includes a plurality of I/O units 10. The plurality of I/O units 10 are arranged in the width direction.

The control device is, for example, a numerical control device that controls a machine tool. The control device is not shown. The device is, for example, an actuator, a detector, or the like provided in the machine tool. The device includes an external terminal 14 and a cable 14a. The external terminal 14 is a terminal connected to the I/O unit 10. The cable 14a is a member that connects the main body of the device and the external terminal 14. The main body of the device is not shown.

The communication system 11 may further include an installation member 13. The installation member 13 is a member that supports the plurality of I/O units 10. The installation member 13 is, for example, a DIN rail. The extending direction of the installation member 13 illustrated in FIG. 1A is the width direction. That is, the installation member 13 is long in the width direction. In this case, the plurality of I/O units 10 are consecutively arranged on the installation member 13. The plurality of I/O units 10 are installed in the front portion of the installation member 13.

The I/O unit 10 includes a communication processing unit 16, a base unit 18, and a front unit 20. The communication processing unit 16, the base unit 18, and the front unit 20 are arranged in the front-rear direction. The communication processing unit 16 is disposed on the rear side of the front unit 20, and the base unit 18 is disposed on the rear side of the communication processing unit 16.

The communication processing unit 16 is a member that houses a control module 22. The control module 22 is a module that performs processing necessary for establishing communication between the control device and the device. The control module 22 includes, for example, a circuit board with a predetermined electric circuit formed thereon. The electric circuit includes, for example, a control integrated circuit (IC).

The base unit 18 is a member that supports the communication processing unit 16 in an insertable and removable manner. The insertion direction in which the communication processing unit 16 is inserted into the base unit 18 is the rearward direction. The removal direction in which the communication processing unit 16 is removed from the base unit 18 is the forward direction.

The base unit 18 includes a plurality of base terminals 24. The plurality of base terminals 24 are provided on a side portion of the base unit 18. The plurality of base terminals 24 include base terminals 24L on a side portion of the base unit 18 that is on the L-direction side and base terminals 24R on a side portion of the base unit 18 that is on the R-direction side.

In one I/O unit 10, the plurality of base terminals 24L and the plurality of base terminals 24R are connected to the control module 22 when the communication processing unit 16 is inserted into the base unit 18. Therefore, the plurality of base terminals 24L and the plurality of base terminals 24R are connected to each other via the control module 22 by inserting the communication processing unit 16 into the base unit 18.

When two I/O units 10 are adjacent to each other in the width direction, the plurality of base terminals 24R of the I/O unit 10 on the L-direction side and the plurality of base terminals 24L of the I/O unit 10 on the R-direction side are connected to each other. Thus, the control modules 22 of the two I/O units 10 adjacent to each other in the width direction are connected to each other.

Further, the base terminals 24L of the I/O unit 10 arranged at the most L-direction side among the plurality of I/O units 10 connected in series are connected to the control device. As a result, the control module 22 of that I/O unit 10 is connected to the control device. Further, the control modules 22 of the other I/O units 10 are connected to the control device via the control module 22 of that I/O unit 10. Accordingly, the device connected to each of the I/O units 10 is connected to the control device via at least one I/O unit 10 (control module 22).

However, the plurality of base terminals 24R of the I/O unit 10 arranged on the most R-direction side among the plurality of I/O units 10 connected in series may be connected to the control device. In this case also, the device connected to each of the I/O units 10 is connected to the control device via at least one I/O unit 10 (control module 22).

The front unit 20 is a terminal block that is attachable to and detachable from the communication processing unit 16. The attaching direction in which the front unit 20 is attached to the communication processing unit 16 is the rearward direction. The detaching direction in which the front unit 20 is detached from the communication processing unit 16 is the forward direction.

The I/O unit 10 preferably has a flat plate shape in appearance. The thickness direction of the flat plate shape is the width direction. In a case that the I/O unit 10 has a flat plate shape that is thin in the width direction, the plurality of I/O units 10 require less installation space.

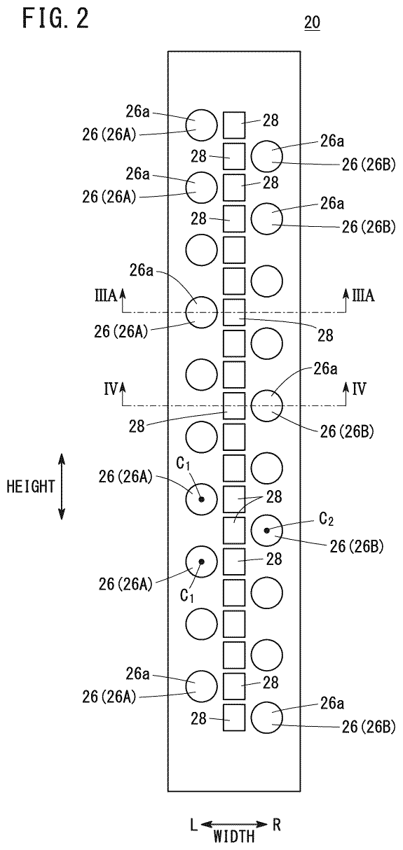

FIG. 2 is a front view of the front unit 20.

The front unit 20 will be further described below. In the following description, the height direction is also referred to as a longitudinal direction or a long-side direction. The width direction is also referred to as a transverse direction or a short-side direction.

The front unit 20 includes a plurality of insertion-receiving portions 26 and a plurality of release operating elements 28.

Each of the plurality of insertion-receiving portions 26 is a portion into which the external terminal 14 is inserted. Each of the plurality of insertion-receiving portions 26 has an opening 26a formed in the front surface of the front unit 20 such that, for example, the external terminal 14 can be fitted into the insertion-receiving portion. However, each of the plurality of insertion-receiving portions 26 is not limited to the opening 26a. Each of the plurality of insertion-receiving portions 26 may have a mechanism for sandwiching and holding the external terminal 14.

The plurality of insertion-receiving portions 26 include a plurality of first insertion-receiving portions 26A and a plurality of second insertion-receiving portions 26B. Each of the plurality of first insertion-receiving portions 26A has a center C₁. Each of the plurality of second insertion-receiving portions 26B has a center C₂. However, in FIG. 2, illustration of the centers C₁ of some of the first insertion-receiving portions 26A and the centers C₂ of some of the second insertion-receiving portions 26B is omitted.

The plurality of first insertion-receiving portions 26A are arranged in a row along the height direction. The plurality of second insertion-receiving portions 26B are also arranged in a row along the height direction. However, the plurality of first insertion-receiving portions 26A and the plurality of second insertion-receiving portions 26B are disposed at positions different from each other in the width direction.

The plurality of first insertion-receiving portions 26A and the plurality of second insertion-receiving portions 26B are also arranged at positions different from each other in the height direction. The center C₂ of each of the second insertion-receiving portions 26B is located between the centers C₁ of the two first insertion-receiving portions 26A that sandwich that second insertion-receiving portion 26B, in the height direction. The plurality of first insertion-receiving portions 26A and the plurality of second insertion-receiving portions 26B may overlap each other in position in the height direction.

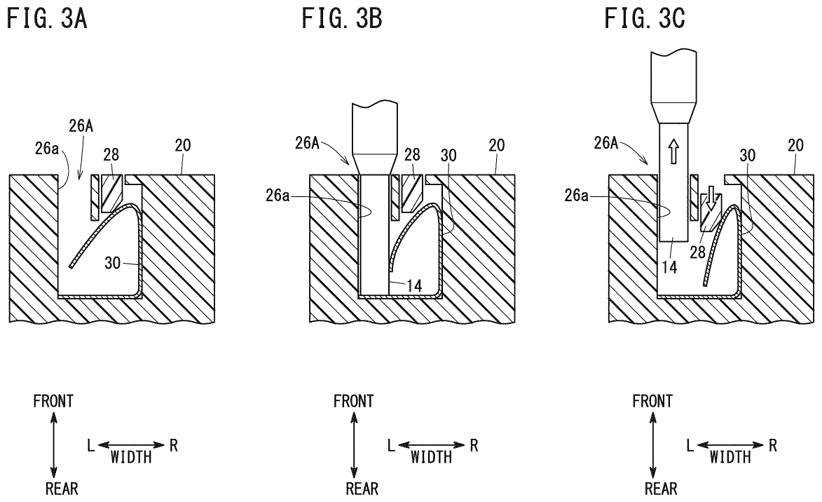

The plurality of release operating elements 28 are operating elements provided corresponding to the plurality of insertion-receiving portions 26, respectively. Each of the plurality of release operating elements 28 is, for example, a pusher. Each of the insertion-receiving portions 26 is provided with a connection terminal 30 for connection to the external terminal 14 (see also FIG. 3A). Each of the release operating elements 28 is operated by an operator to release the connection between the corresponding connection terminal 30 and the external terminal 14 connected to that connection terminal 30.

The plurality of release operating elements 28 are arranged at positions different from the positions of the plurality of insertion-receiving portions 26 in the width direction. In the present embodiment, all the release operating elements 28 are disposed between the plurality of first insertion-receiving portions 26A and the plurality of second insertion-receiving portions 26B in the width direction. In the present embodiment, all the release operating elements 28 are arranged in a row along the height direction.

FIG. 3A is an end view taken along line IIIA-IIIA of FIG. 2.

Each of the plurality of first insertion-receiving portions 26A is provided with the connection terminal 30 as described above. The connection terminal 30 is disposed rearward of the opening 26a, in the first insertion-receiving portion 26A. The connection terminal 30 is formed into, for example, a plate spring shape and has elasticity. The connection terminal 30 of each of the first insertion-receiving portions 26A is connected to the control module 22 by the front unit 20 being attached to the communication processing unit 16.

FIG. 3B is an end view showing a state where the external terminal 14 is inserted into the first insertion-receiving portion 26A in FIG. 3A.

The connection terminal 30 is in contact with the external terminal 14 inserted into the opening 26a. Thus, the connection terminal 30 and the external terminal 14 are connected to each other. The connection terminal 30 and the external terminal 14 are connected to each other, whereby the device and the control module 22 are connected to each other.

Further, since the connection terminal 30 has elasticity, the connection terminal 30 can press the external terminal 14 in the width direction. The external terminal 14 is locked into the first insertion-receiving portion 26A by being pressed in the width direction. In the example of FIG. 3B, the connection terminal 30 presses the external terminal 14 in the L-direction.

FIG. 3C is an end view showing a state in which the operator operates the release operating element 28 in FIG. 3B.

The operator can push the release operating element 28 in the rearward direction. By this pushing operation, the release operating element 28 is inserted between the connection terminal 30 and the external terminal 14. The release operating element 28 is inserted between the connection terminal 30 and the external terminal 14, and as a result, the contact between the connection terminal 30 and the external terminal 14 is released. When the contact between the connection terminal 30 and the external terminal 14 is released, the pressing of the connection terminal 30 against the external terminal 14 is released. The operator can easily take out the external terminal 14 from the first insertion-receiving portion 26A by releasing the pressing of the connection terminal 30 against the external terminal 14.

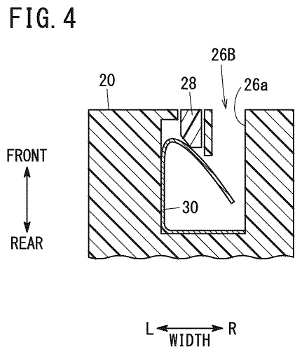

FIG. 4 is an end view taken along line IV-IV of FIG. 2.

The connection terminals 30 are also provided in the second insertion-receiving portions 26B, respectively. It is preferable that the internal structure of each second insertion-receiving portion 26B and the internal structure of each first insertion-receiving portion 26A have structures substantially symmetrical to each other in the width direction with the release operating element 28 as the center (see FIG. 3A and FIG. 4). Thus, the components such as the connection terminal 30 and the release operating element 28 can be configured as common parts for all the insertion-receiving portions 26.

The above is a configuration example of the front unit 20. The positions of the first insertion-receiving portions 26A in the width direction may be misaligned. That is, the positions of the centers C₁ of the plurality of first insertion-receiving portions 26A in the width direction may be different from each other. Similarly, the positions of the centers C₂ of the plurality of second insertion-receiving portions 26B in the width direction may be different from each other.

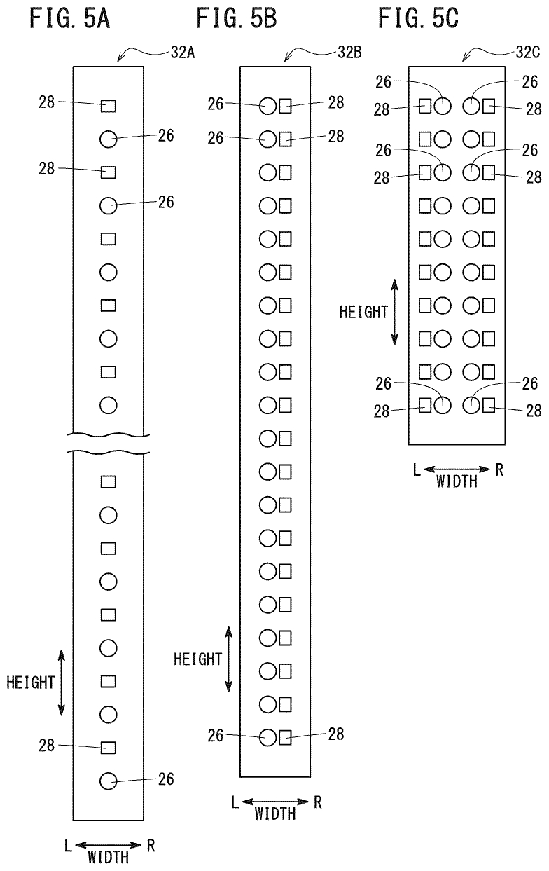

FIG. 5A is a front view of a front unit 32A in Comparative Example 1 to which the present embodiment is not applied.

In the front unit 32A, the plurality of insertion-receiving portions 26 and the plurality of release operating elements 28 are alternately arranged in a row along the height direction. The front unit 32A has at least the following problems.

A first problem of the front unit 32A is that it is too large in the height direction. Since the plurality of insertion-receiving portions 26 and the plurality of release operating elements 28 are alternately arranged in a row along the height direction, the front unit 32A is likely to be larger in the height direction as the number of insertion-receiving portions 26 and the number of release operating elements 28 are larger.

A second problem of the front unit 32A is that the operability of the operator is poor. For example, the operator performs an operation of connecting the external terminal 14 to each of the plurality of insertion-receiving portions 26. In this operation, the external terminal 14 is connected to an insertion-receiving portion 26 that is at a relatively upper position, among the plurality of insertion-receiving portions 26 arranged in the height direction. In this case, the cable 14a connected to the external terminal 14 droops, and thus the other insertion-receiving portions 26 are hidden behind the cable 14a. Since the insertion-receiving portions 26 are hidden behind the cable 14a, it is difficult for the operator to perform the operation of connecting other external terminals 14 to the insertion-receiving portions 26 hidden behind the cable 14a.

Further, for example, the operator performs an operation of operating one of the plurality of release operating elements 28. In this operation, the external terminal 14 is connected to at least one of the two insertion-receiving portions 26 adjacent, in the height direction, to the release operating element 28 to be operated. In this case, the external terminal 14 may hinder the operator from operating the release operating element 28.

The second problem of the front unit 32A is solved to some extent by widening the interval between the insertion-receiving portion 26 and the release operating element 28 adjacent to each other in the height direction. However, when the interval between the insertion-receiving portion 26 and the release operating element 28 adjacent to each other in the height direction is widened, the first problem described above is further worsened.

FIG. 5B is a front view of a front unit 32B in Comparative Example 2 to which the present embodiment is not applied.

In order to solve the first problem of the front unit 32A, it is conceivable to arrange the plurality of insertion-receiving portions 26 and the plurality of release operating elements 28 at positions different from each other in the width direction. That is, the front unit 32B of FIG. 5B is conceivable. In the front unit 32B, the plurality of insertion-receiving portions 26 and the plurality of release operating elements 28 are arranged at different positions in the width direction. The front unit 32B is smaller than the front unit 32A in the height direction.

However, the front unit 32B is still large. That is, in the front unit 32B, the plurality of insertion-receiving portions 26 are adjacent to each other in the height direction. When the interval between the adjacent insertion-receiving portions 26 is small, there is a concern that operability of the operator may deteriorate. For example, in a state where the external terminal 14 has already been connected to one of the two adjacent insertion-receiving portions 26, the operator inserts another external terminal 14 into the other of the insertion-receiving portions 26 that is empty. Here, if the interval between the two insertion-receiving portions 26 is small, the external terminal 14 that has already been connected may hinder the operator from doing the operation. In view of this, the interval in the height direction between the insertion-receiving portions 26 adjacent to each other in the height direction needs to be increased to such an extent that the operability of the operator is not deteriorated. As a result, the front unit 32B can be made smaller than the front unit 32A, but there is a problem that the front unit 32B has to be designed to be large in the height direction in consideration of the above-described need to increase the interval.

FIG. 5C is a front view of a front unit 32C in Comparative Example 3 to which the present embodiment is not applied.

It might be possible to conceive the front unit 32C in FIG. 5C as a terminal block that is smaller in the height direction than the front unit 32A or the front unit 32B. In the front unit 32C, the plurality of insertion-receiving portions 26 and the plurality of release operating elements 28 are arranged at positions different from each other in the width direction. In the front unit 32C, the plurality of insertion-receiving portions 26 are arranged in a plurality of rows. In this case, in a simplistic point of view, the front unit 32C can be made half or less the height of the front unit 32B.

However, if the plurality of insertion-receiving portions 26 are simply arranged in a plurality of rows, as shown in FIG. 5C, at least two insertion-receiving portions 26 arranged at the same position in the height direction and the two release operating elements 28 corresponding thereto are arranged along the width direction. In this case, the size of the front unit 32C in the width direction is doubled as compared with the front unit 32A and the front unit 32B, in a simple point of view. In this example, the number of rows of the plurality of insertion-receiving portions 26 is considered to be two. However, if the number of rows of the plurality of insertion-receiving portions 26 is three or more, the widthwise length of the front unit 32C is further increased. Such a front unit 32C is not suitable for the flat plate-shaped I/O unit 10 which is preferably thin, even though it is small in the height direction.

In this regard, according to the present embodiment, the plurality of insertion-receiving portions 26 are arranged in two rows (see also FIG. 2). Thus, the front unit 20 can be made smaller in the height direction than the front unit 32A and the front unit 32B.

Further, according to the present embodiment, the plurality of release operating elements 28 and the plurality of insertion-receiving portions 26 are arranged at different positions in the width direction. Therefore, the release operating elements 28 of the front unit 20 are less likely to be hidden behind the cables 14a.

Further, according to the present embodiment, the plurality of first insertion-receiving portions 26A and the plurality of second insertion-receiving portions 26B are different in position in the height direction. Thus, the plurality of release operating elements 28 corresponding respectively to the first insertion-receiving portions 26A and the plurality of release operating elements 28 corresponding respectively to the second insertion-receiving portions 26B can be arranged in a row in the height direction. Thus, the front unit 20 is thinner than the front unit 32C.

As described above, the front unit (terminal block) 20 of the present embodiment is suitable for application to a small and thin electronic device (I/O unit 10), and has good operability for an operator.

### Modifications

Modifications of the above-described embodiment will be described below. However, explanations that overlap with those of the embodiment will be omitted insofar as possible in the following description. Elements that have been described in the above embodiment are denoted by the same reference numerals as in the above embodiment unless otherwise specified.

### (Modification 1)

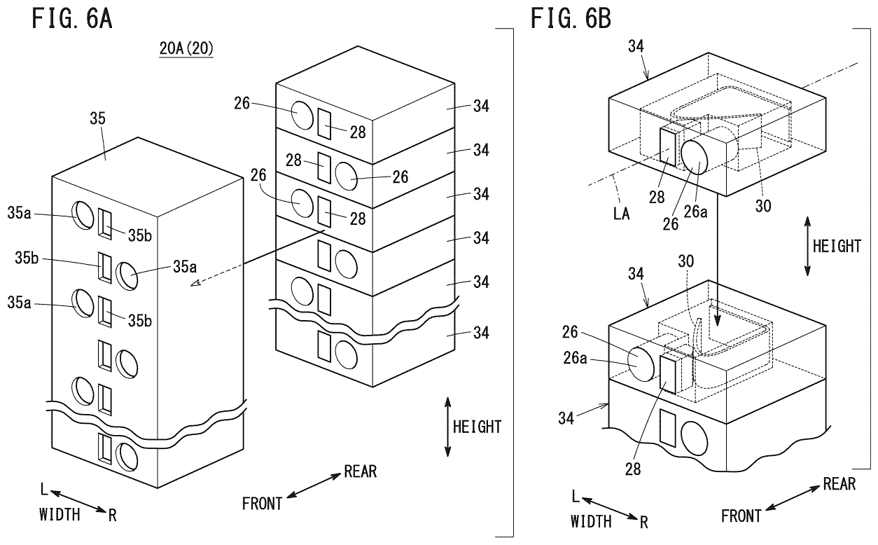

FIG. 6A is a perspective view of a front unit 20A (20) according to Modification 1.

The front unit 20A includes a plurality of connector units 34. The plurality of connector units 34 are stacked in the height direction.

The front unit 20A may further include a predetermined housing 35. The housing 35 is a member that houses the stacked connector units 34. The housing 35 is formed with a plurality of openings 35a arranged in correspondence with the plurality of insertion-receiving portions 26 and a plurality of openings 35b arranged in correspondence with the plurality of release operating elements 28.

Each opening 35a exposes the corresponding insertion-receiving portion 26 to the outside of the housing 35 when the plurality of connector units 34 are accommodated in the housing 35. When the plurality of connector units 34 are accommodated in the housing 35, each opening 35b exposes the corresponding release operating element 28 to the outside of the housing 35.

FIG. 6B is a view showing a plurality of connector units 34 stacked in the height direction.

The connector unit 34 includes an insertion-receiving portion 26, a release operating element 28, and a connection terminal 30. In each connector unit 34, the arrangement of the insertion-receiving portion 26, the release operating element 28, and the connection terminal 30 is in accordance with FIG. 3A or FIG. 4. The axis LA shown in FIG. 6B passes through the widthwise center of the connector unit 34. The axis LA is parallel to the front-rear direction.

In the front unit 20A, one of two connector units 34 adjacent to each other in the height direction is stacked on the other connector unit 34 in a state of being rotated by 180 degrees about the axis LA parallel to the front-rear direction. That is, the connector unit 34 in which the opening 26a is positioned on the L-direction side with respect to the release operating element 28 and the connector unit 34 in which the opening 26a is positioned on the R-direction side with respect to the release operating element 28 are alternately arranged.

According to the present modification, the insertion-receiving portion 26 of the connector unit 34 whose opening 26a is positioned on the L-direction side with respect to the release operating element 28, is, for example, the first insertion-receiving portion 26A. In this case, the insertion-receiving portion 26 of the connector unit 34 whose opening 26a is positioned on the R-direction side with respect to the release operating element 28 is the second insertion-receiving portion 26B.

That is, according to the present modification, the plurality of first insertion-receiving portions 26A are arranged in a row in the height direction by stacking the plurality of connector units 34. The second insertion-receiving portions 26B are arranged in a row in the height direction at positions different from the positions of the first insertion-receiving portions 26A in the widthwise direction. Further, the plurality of release operating elements 28 are arranged in a row in the height direction between the plurality of first insertion-receiving portions 26A and the plurality of second insertion-receiving portions 26B.

Therefore, according to the present modification, the front unit 20A that exhibits the same operational effects as the front unit 20 of the embodiment can be easily manufactured by a simple method of stacking the plurality of connector units 34.

### (Modification 2)

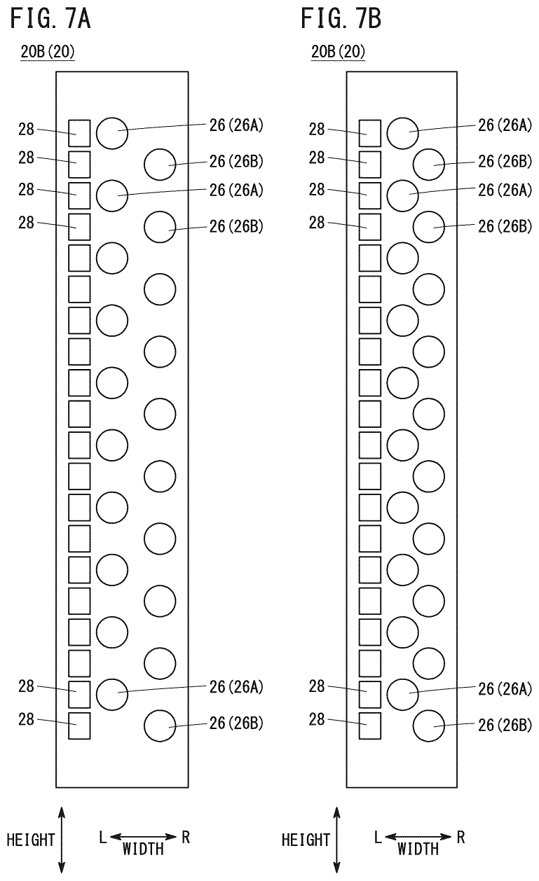

FIG. 7A is a front view of a front unit 20B (20) according to Modification 2.

The order of arrangement of the first insertion-receiving portion 26A, the second insertion-receiving portion 26B, and the release operating element 28 in the widthwise direction is not limited to the example of FIG. 2.

For example, the plurality of first insertion-receiving portions 26A may be disposed between the plurality of release operating elements 28 and the plurality of second insertion-receiving portions 26B in the width direction (FIG. 7A). Alternatively, the plurality of second insertion-receiving portions 26B may be disposed between the plurality of release operating elements 28 and the plurality of first insertion-receiving portions 26A in the width direction.

FIG. 7B is a front view of another example of the front unit 20B (20) according to the second modification.

The positions of the plurality of first insertion-receiving portions 26A and the plurality of second insertion-receiving portions 26B in the widthwise direction may overlap. This makes it possible to further reduce the thickness of the front unit 20B in the width direction.

### (Modification 3)

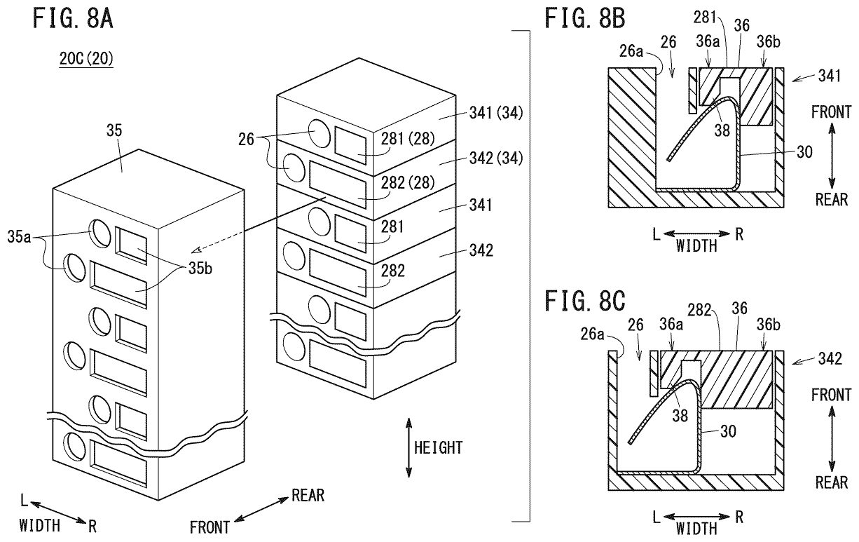

FIG. 8A is a perspective view of a front unit 20C (20) according to Modification 3.

The first modification and the second modification may be combined. For example, the front unit 20C includes a plurality of connector units 34 (341, 342). The plurality of connector units 34 of the front unit 20C include a plurality of first units 341 and a plurality of second units 342. The first units 341 and the second units 342 are alternately stacked. The number of the stacked connector units 34 is not particularly limited.

The front unit 20C may further include a housing 35. The housing 35 houses the plurality of connector units 34 stacked together. The plurality of openings 35a and the plurality of openings 35b formed in the housing 35 are appropriately modified according to the configuration of each of the first unit 341 and the second unit 342 described later.

FIG. 8B is a diagram schematically showing an internal configuration of the first unit 341. FIG. 8C is a diagram schematically showing an internal configuration of the second unit 342.

The first unit 341 includes an insertion-receiving portion 26, a release operating element 281 (28), and a connection terminal 30. The second unit 342 includes an insertion-receiving portion 26, a release operating element 282 (28), and a connection terminal 30.

The first unit 341 and the second unit 342 are different from each other in the widthwise position (position in the width direction) of the opening 26a of the insertion-receiving portion 26. Accordingly, the first unit 341 and the second unit 342 may be different from each other in the widthwise position of the connection terminal 30.

Therefore, when the plurality of first units 341 and the plurality of second units 342 are stacked, the widthwise position of the opening 26a of each first unit 341 is different from the widthwise position of the opening 26a of each second unit 342.

The plurality of release operating elements 281 and the plurality of release operating elements 282 are arranged on the L-direction side or the R-direction side relative to the opening 26a. When each release operating element 281 is disposed on the L-direction side of the opening 26a, each release operating element 282 is also disposed on the L-direction side of the opening 26a. When each of the release operating elements 281 is disposed on the R-direction side of the opening 26a, each of the release operating elements 282 is also disposed on the R-direction side of the opening 26a.

Therefore, when the plurality of first units 341 and the plurality of second units 342 are stacked, the plurality of release operating elements 281 and the plurality of release operating elements 282 are arranged in a row in the height direction.

Each of the release operating elements 281 includes a first portion 36 and a second portion 38.

The first portion 36 is a portion extending in the width direction. The first portion 36 has an end 36a closer to the opening 26a and an end 36b further from the opening 26a. Here, at least the end 36b of the first portion 36 is exposed to the outside so that the operator can perform a pushing operation. The first portion 36 moves in the rearward direction in response to the pushing operation by the operator. The first portion 36 moves in the forward direction in response to the release of the pushing operation by the operator.

The second portion 38 is a portion for operating the connection terminal 30 in response to the operator's pushing operation of the first portion 36. That is, similarly to the release operating element 28 in FIG. 3C, the second portion 38 is a portion for being inserted between the connection terminal 30 and the external terminal 14 to thereby release the connection between the connection terminal 30 and the external terminal 14.

The second portion 38 extends from the first portion 36 in the rearward direction. The second portion 38 moves in the rearward direction together with the first portion 36 in response to the first portion 36 being pushed. The second portion 38 moves in the forward direction together with the first portion 36 in response to the release of the pushing operation of the first portion 36.

The release operating element 282 also includes a first portion 36 and a second portion 38. However, the first portion 36 of the release operating element 282 and the first portion 36 of the release operating element 281 have different lengths in the width direction in accordance with the difference in the position of the connection terminal 30 in the width direction between the first unit 341 and the second unit 342. That is, the first portion 36 illustrated in FIG. 8C is longer in the width direction than the first portion 36 illustrated in FIG. 8B.

The front unit 20C can be easily manufactured by alternately stacking the first units 341 and the second units 342 in the height direction.

### (Combination of Plurality of Modifications)

The above-described modifications may be appropriately combined within a range in which no technical inconsistencies occur.

### Invention Obtained from Embodiments

The inventions that can be grasped from the above-described embodiment and the modifications thereof will be described below.

### <First Aspect of Invention>

A first aspect of the present invention is characterized by the terminal block (20) including: the plurality of insertion-receiving portions (26) into which the plurality of external terminals (14) are inserted, respectively, and which are provided respectively with the plurality of connection terminals (30) each connected to a corresponding one of the inserted external terminals; and the plurality of release operating elements (28) each configured to release connection between a corresponding one of the plurality of external terminals and a corresponding one of the plurality of connection terminals, wherein the plurality of insertion-receiving portions include: the plurality of first insertion-receiving portions (26A) arranged in a row along the first direction; and the plurality of second insertion-receiving portions (26B) arranged in a row along the first direction at positions that are different from the positions of the plurality of first insertion-receiving portions in the second direction orthogonal to the first direction, and wherein the plurality of second insertion-receiving portions are disposed at positions that are different from the positions of the plurality of first insertion-receiving portions in the first direction, and the plurality of release operating elements corresponding to the plurality of first insertion-receiving portions and the plurality of release operating elements corresponding to the plurality of second insertion-receiving portions are arranged along the first direction at positions that are different from the positions of the plurality of first insertion-receiving portions and the positions of the plurality of second insertion-receiving portions in the second direction.

Thus, it is possible to provide a terminal block suitable for application to a small and thin electronic device.

The plurality of release operating elements corresponding to the plurality of first insertion-receiving portions and the plurality of release operating elements corresponding to the plurality of second insertion-receiving portions may be disposed between the plurality of first insertion-receiving portions and the plurality of second insertion-receiving portions in the second direction. Thus, the plurality of release operating elements corresponding to the plurality of first insertion-receiving portions and the plurality of release operating elements corresponding to the plurality of second insertion-receiving portions can be arranged substantially in a row, and hence the terminal block can be further reduced in width.

The terminal block may have a shape in which the first direction is a long-side direction and the second direction is a short-side direction when viewed in a direction orthogonal to the first direction and the second direction. This makes the terminal block more preferable for application to an electronic device that is thin in the width direction.

### <Second Aspect of Invention>

A second aspect of the present invention is characterized by the I/O unit (10) including the terminal block according to the first aspect, wherein the I/O unit has a flat plate shape, and the thickness direction of the flat plate shape is the second direction.

Thus, it is possible to provide a terminal block suitable for application to a small and thin electronic device.

### REFERENCE SIGNS LIST

10: I/O unit
14: external terminal
20, 20A to 20C: front unit (terminal block)
26: insertion-receiving portion
26A: first insertion-receiving portion
26B: second insertion-receiving portion
28: release operating element
30: connection terminal

1. A terminal block comprising:
a plurality of insertion-receiving portions into which a plurality of external terminals are inserted, respectively, and which are provided respectively with a plurality of connection terminals each connected to a corresponding one of the inserted external terminals; and
a plurality of release operating elements each configured to release connection between a corresponding one of the plurality of external terminals and a corresponding one of the plurality of connection terminals,
wherein
the plurality of insertion-receiving portions include:
a plurality of first insertion-receiving portions arranged in a row along a first direction; and
a plurality of second insertion-receiving portions arranged in a row along the first direction at positions that are different from positions of the plurality of first insertion-receiving portions in a second direction orthogonal to the first direction, and
wherein
the plurality of second insertion-receiving portions are disposed at positions that are different from the positions of the plurality of first insertion-receiving portions in the first direction, and
the plurality of release operating elements corresponding to the plurality of first insertion-receiving portions and the plurality of release operating elements corresponding to the plurality of second insertion-receiving portions are arranged along the first direction at positions that are different from the positions of the plurality of first insertion-receiving portions and the positions of the plurality of second insertion-receiving portions in the second direction.

2. The terminal block according to claim 1, wherein
the plurality of release operating elements corresponding to the plurality of first insertion-receiving portions and the plurality of release operating elements corresponding to the plurality of second insertion-receiving portions are disposed between the plurality of first insertion-receiving portions and the plurality of second insertion-receiving portions in the second direction.

3. The terminal block according to claim 1, wherein
the terminal block has a shape in which the first direction is a long-side direction and the second direction is a short-side direction when viewed in a direction orthogonal to the first direction and the second direction.

4. An I/O unit comprising the terminal block according to claim 1, wherein
the I/O unit has a flat plate shape, and a thickness direction of the flat plate shape is the second direction.
